(19) United States
(12) Patent Application Publication
(10) Pub. No.: US 2025/0150429 A1
(43) Pub. Date: May 8, 2025

(54) SYSTEMS AND METHODS FOR FILTERING OF MALICIOUS DNS QUERIES

(71) Applicant: Level 3 Communications, LLC, Denver, CO (US)

(72) Inventor: Michael Feldpusch, Murrells Inlet, SC (US)

(73) Assignee: Level 3 Communications, LLC, Denver, CO (US)

(21) Appl. No.: 18/914,963

(22) Filed: Oct. 14, 2024

Related U.S. Application Data
(60) Provisional application No. 63/595,886, filed on Nov. 3, 2023.

(51) Int. Cl. H04L 61/4511

(52) U.S. Cl. CPC H04L 61/4511

(57) ABSTRACT

The present application describes systems and methods for filtering of malicious domain name system (DNS) queries. A DNS filter inspects a DNS query and drops the DNS query if the DNS query is deemed invalid. The DNS filter allows or drops the DNS query based on a set of rules. The set of rules includes one or more criteria for the validity or invalidity one or more DNS query attributes. The DNS filter logs the dropped DNS queries and provides them to the security analysis service for further investigation. In some examples, the DNS filter runs in a container or a virtual machine (VM) on the same system as the DNS server, or on a separate system in-line with the DNS servers.

### CROSS-REFERENCE TO RELATED APPLICATIONS

This application claims the benefit of U.S. Provisional Application No. 63/595,886 filed Nov. 3, 2023, entitled “Systems and Methods for Filtering of Malicious DNS Queries,” which is incorporated herein by reference in its entirety.

### BACKGROUND

A domain name system (DNS) (e.g., including a DNS server) refers to a system that translates domain names or host names into internet protocol (IP) addresses, allowing users to access websites and other online services over the Internet. A DNS server is responsible for providing DNS responses to DNS queries from user devices. It is with respect to this general technical environment that aspects of the present application are directed.

### SUMMARY

The present application describes systems and methods for filtering of malicious domain name system (DNS) queries.

In an aspect, the present application relates to a system, comprising at least one processor, and memory, operatively connected to the at least one processor and storing instructions that, when executed by the at least one processor, cause the system to perform a method. In examples, the method includes: receiving a first domain name system (DNS) query from a computing device, wherein the first DNS query comprises a domain name; inspecting the DNS query based at least in part on a set of rules; determining that the DNS query is either valid or invalid based at least in part on the inspection; dropping the DNS query when the DNS query is invalid; generating, when the first DNS query is valid, a second DNS query from the DNS filter system to a DNS server, wherein the second DNS query comprises the domain name; and sending the second DNS query.

In some examples, when the DNS query is invalid, the method further includes: logging the first DNS query; and providing the first DNS query to a security analysis service. In some examples, the security analysis service is configured to update the set of rules based on external data, log analysis data, internal data, or a combination thereof. In some examples, when the first DNS query is valid, the method further may include rewriting a source address of the second DNS query to an original source address. In some examples, the DNS filter is implemented as a container or a virtual machine (VM) running on a same system or a different system as the DNS server. In some examples, the set of rules includes one or more criteria for one or more DNS query attributes, the one or more DNS query attributes may include a validity of a query type, a validity of a DNS query payload, a validity of a source address of the first DNS query, or a combination thereof. In some examples, dropping the first DNS query is based at least in part on determining that the one or more DNS query attributes are indicative of a DNS related attack. In some examples, the DNS server is a DNS cache server or a DNS authoritative server. In some examples, the DNS server is a DNS cache server, and the method further includes generating and providing a third DNS query to a second system configured to implement a second DNS filter, a DNS authoritative server, or both.

In another aspect, the present application relates to a system, comprising at least one processor, and memory, operatively connected to the at least one processor and storing instructions that, when executed by the at least one processor, cause the system to perform a method. In examples, the method includes: receiving a first domain name system (DNS) query from a computing device, wherein the first DNS query comprises a domain name; inspecting the DNS query based at least in part on a set of rules; determining that the DNS query is either valid or invalid based at least in part on the inspection; dropping the DNS query when the DNS query is invalid; generating, when the first DNS query is valid, a second DNS query from the DNS filter system to a DNS server, wherein the second DNS query comprises the domain name and the generating comprises rewriting a source address of the second DNS query to an original source address of the first DNS query; and sending the second DNS query.

In some examples, when the DNS query is invalid, the method further includes: logging the first DNS query; and providing the first DNS query to a security analysis service. In some examples, the security analysis service is configured to update the set of rules based on external data, log analysis data, internal data, or a combination thereof. In some examples, the DNS filter is implemented as a container or a virtual machine (VM) running on a same system or a different system as the DNS server. In some examples, the set of rules includes one or more criteria for one or more DNS query attributes, the one or more DNS query attributes may include a validity of a query type, a validity of a DNS query payload, a validity of a source address of the first DNS query, or a combination thereof. In some examples, dropping the first DNS query is based at least in part on determining that the one or more DNS query attributes are indicative of a DNS related attack. In some examples, the DNS server is a DNS cache server or a DNS authoritative server. In some examples, the DNS server is a DNS cache server, and the method further includes generating and providing a third DNS query to a second system configured to implement a second DNS filter, a DNS authoritative server, or both.

In yet another aspect, the present application relates to a method. The method includes receiving, at a domain name system (DNS) filter system, a first DNS query from a computing device, wherein the first DNS query comprises a domain name; inspecting the first DNS query based at least in part on a set of rules; determining that the first DNS query is either valid or invalid based at least in part on the inspection; dropping the first DNS query when the first DNS query is invalid; generating, when the first DNS query is valid, a second DNS query from the DNS filter system to a DNS server, wherein the second DNS query comprises the domain name and the generating comprises rewriting a source address of the second DNS query to an original source address of the first DNS query; and sending the second DNS query.

In examples, when the first DNS query is invalid, the method further comprises: logging the first DNS query; and providing the first DNS query to a security analysis service. In examples, the set of rules comprises one or more criteria for the validity or invalidity of one or more DNS query attributes, the one or more DNS query attributes comprising a query type, a DNS query payload, a source address of the first DNS query, or a combination thereof.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram depicting an example system according to aspects of the present application.

FIG. 2 is a block diagram depicting an example system according to aspects of the present application.

FIG. 3 is a process flow diagram depicting an example process flow according to aspects of the present application.

FIG. 4 is a flowchart depicting an example method according to aspects of the present application.

FIG. 5 is a block diagram depicting an example computing environment in which systems and methods of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. In addition, all systems described with respect to the Figures can comprise one or more machines or devices that are operatively connected to cooperate in order to provide the described system functionality. The following detailed description is therefore not to be taken in a limiting sense, and the scope of the present disclosure is defined by the appended claims and their equivalents.

A domain name system (DNS) refers to a system (e.g., including a DNS server) that translates domain names or host names (collectively referred to as domain names) into internet protocol (IP) addresses, e.g., allowing users to access websites and other online services. However, the DNS server may be vulnerable to various types of DNS related attacks, such as DNS Distributed Denial-of-Service (DDoS) attacks, that aim to disrupt or degrade the normal functioning of the DNS server. DDoS attacks may cause significant problems for both users and service providers, such as slow or failed connections, increased network traffic, and reduced performance. Some examples of DDoS attacks are dictionary attacks and water torture attacks, which generate random or malicious DNS queries to overwhelm the DNS servers or the network bandwidth. In some cases, customers may still be affected by DNS related attacks despite vendor efforts to mitigate the DNS related attacks. A solution to mitigate DNS related attacks is thus desirable.

Technology described herein relates to systems and methods for filtering of malicious DNS queries. A DNS filter system (e.g., an inline DNS filter) inspects a DNS query from a computing device (e.g., computing device of a user) and drops the DNS query if the DNS query is deemed invalid. The DNS filter allows or drops the DNS query based on a set of rules. The set of rules includes one or more criteria for determining the validity or invalidity one or more DNS query attributes (e.g., a query type, a DNS query payload, a source address of the DNS query, among other DNS query attributes). The DNS filter logs the dropped DNS queries and may provide them to a security analysis service for further investigation. In some examples, the set of rules is updated by the security analysis service based on external data, log analysis, or internal data. If the DNS query is valid, the DNS filter system may generate a second DNS query for the requested domain name to the DNS server. In some examples, the DNS filter rewrites a source address of the DNS query to be an original source address (e.g., corresponding to the computing device that provided the DNS query) before providing generating a second DNS query for the requested domain name to the DNS server. In examples, this results in the DNS response to the second DNS query being directed from the DNS server to the originally requesting computing device so that responses need not be returned through the DNS filter system. In some examples, the DNS filter runs in a container or a virtual machine (VM) on the same computing system as the DNS server, or on a separate computing system in-line with the DNS server. By using the DNS filter, invalid DNS queries are filtered before they reach DNS servers, thereby reducing the impact of DNS related attacks and improving performance and security.

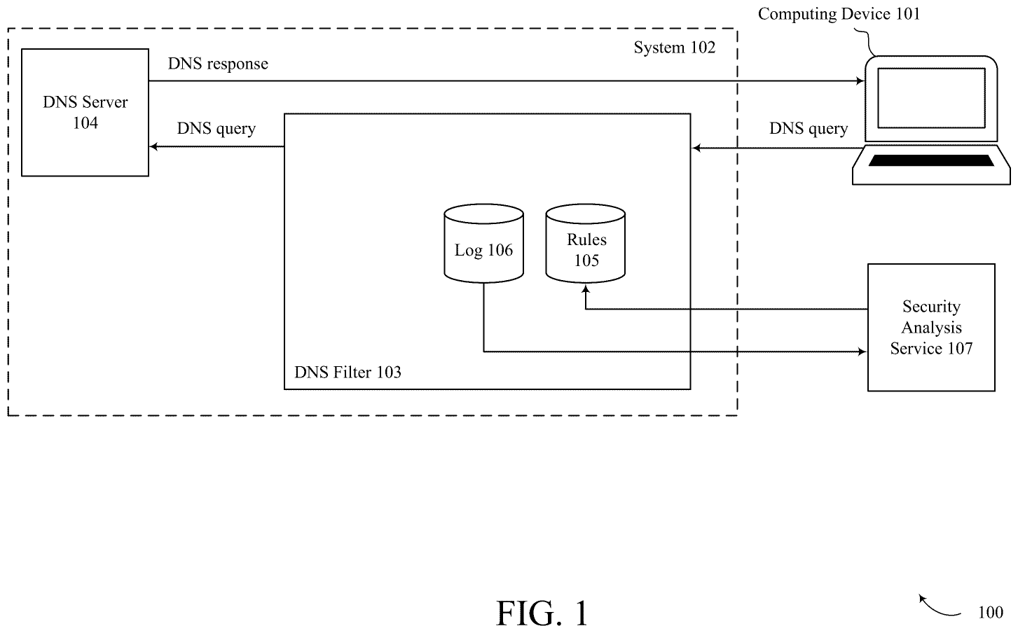

FIG. 1 discloses an example system 100 that implements systems and methods for filtering of malicious DNS queries according to aspects of the present disclosure. System 100, as presented, includes a combination of interdependent components that interact to form an integrated whole. Components of system 100 include hardware components or software components (e.g., containers, VMs) implemented on and/or executed by hardware components of system 100. In some examples, components of system 100 are distributed across multiple processing devices or computing systems.

System 100 may include computing device 101, system 102, DNS filter 103, DNS server 104, rules 105, log 106, and security analysis service 107. The scale and structure of devices and environments discussed herein may vary and may include additional or fewer components than those described in FIG. 1 and subsequent figures.

Computing device 101 represents a computer (e.g., a personal computer (“PC”), a laptop, a server), a mobile device (e.g., smartphone or a tablet), or any other type of electronic processing device. Computing device 101 may provide a first DNS query to DNS filter 103. For example, an advertised IP address of DNS server 104 may be associated with DNS filter 103 so that DNS queries provided to the IP address of DNS server 104 are routed to DNS filter 103. In other examples, the DNS filter may be placed in-line with the DNS server 104 such that all requests to the DNS server 104 must pass through DNS filter 103, and DNS filter 103 intercepts all such requests. In examples, the first DNS query comprises a domain name. A DNS query is a request for one or more IP addresses associated with the provided domain name. For example, computing device 101 may provide the first DNS query to determine an IP address associated with domain name “example.com” entered by a user into an address bar of a browser hosted on computing device 101. Computing device 101 provides the first DNS query, which includes the domain name, to DNS filter 103.

In the depicted example of FIG. 1, system 102 includes DNS filter 103 and DNS server 104. The inclusion of DNS filter 103 and DNS server 104 in a same computing system 102 is optional in some cases. For example, DNS filter 103 and DNS server 104 may be implemented on separate computing systems or devices. For example, DNS filter 103 may be implemented as a separate device, or as a container or VM on a separate device, from DNS server 104. In some other examples, DNS filter 103 and DNS server 104 may be implemented on a same computing system (e.g., system 102). DNS filter 103 may be implemented as a container or a VM on system 102, or as a device that is included in system 102. In some cases, DNS filter 103 is implemented on a DNS server 104 (e.g., as a container or a VM). In such cases, system 102 as a whole may be referred to as a DNS server, with DNS server 104 representing DNS server related software or hardware configured to implement DNS server related functionality (e.g., translation of domain names into IP addresses).

DNS filter 103 receives the first DNS query from computing device 101 and inspects the first DNS query to determine if the first DNS query is valid or invalid based on a set of rules 105. DNS filter 103 stores or otherwise has access to the set of rules 105.

If the first DNS query is invalid, DNS filter 103 may log the first DNS query as log 106 and provide log 106 to security analysis service 107. Security analysis service 107 may comprise a service that performs internet or networking security analysis. Security analysis service 107 may analyze log 106 and update the set of rules 105 based on the analysis of log 106, external data, internal data, or a combination of these.

The set of rules 105 includes one or more criteria for determining the validity or invalidity of one or more DNS query attributes. The one or more DNS query attributes include a query type, a DNS query payload, a source address of the first DNS query, or a combination of these, among other attributes. A query type may refer to A, AAAA, or MX, among other query types. The query type may indicate a type of information that is desired by computing device 101 from the DNS server 104. For example, if an IPv4 address of the domain name is desired, computing device 101 may provide the first DNS query with the query type A. If an IPv6 address of the domain name is desired, computing device 101 may provide the first DNS query with the query type AAAA. If a mail exchange server for the domain name is desired, computing device 101 may provide the first DNS query with the query type MX. The DNS query payload refers to a part of the DNS query that includes information about the domain name that computing device 101 is requesting. For example, if computing device 101 requests an IP address of domain name www.example.com, computing device 101 may provide a first DNS query with a DNS query payload that specifies that hostname (www.example.com). The source address of the first DNS query may refer to the IP address (or other identifier) from which the first DNS query was provided. For example, in system 100, the source address of the first DNS query received by DNS filter 103 refers to an IP address of computing device 101.

In examples, the criteria for determining the validity of the one or more DNS query attributes of the first DNS query may include, among other possibilities, whether the first DNS query recites valid and properly formatted DNS query attributes. The criteria may also include determining whether the DNS query attributes fit a pattern of queries known or suspected to be suspicious or malicious. For example, security analysis service 107 may maintain a continuously updated set of criteria for DNS queries (e.g., drop all DNS queries from certain source addresses known to be currently participating in a DDoS attack, drop all queries having a particular combination of source addresses and query types, drop all queries having a particular payload or payload pattern, etc.). The criteria may be continuously updated, at least in part, based on the log 106 and one or more other internal or external data sources.

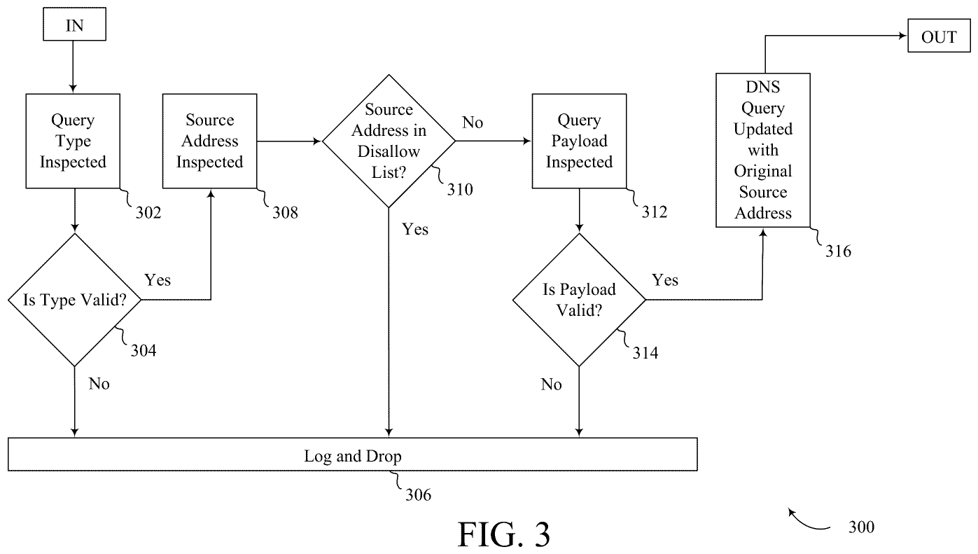

The determination of the validity or invalidity of the DNS query using rules 105 will be discussed further in at least FIG. 3. As mentioned previously, DNS filter 103 may be a device (or component) (e.g., on system 102, or a separate device or component) or may be implemented as a container or a VM (e.g., on system 102, or a separate container or VM implemented on a separate device or component).

If the first DNS query is valid, DNS filter 103 generates a second DNS query from the DNS filter 103 to the DNS server 104 and provides the second DNS query to DNS server 104. In some examples, the second DNS query may comprise the first DNS query, which is forwarded by the DNS filter 103. In other examples, the second DNS query is a newly generated query that includes the same domain name as the first DNS query. In some examples, DNS filter 103 rewrites the source address of the second DNS query to be an original source address before providing the second DNS query to DNS server 104. In the case of FIG. 1, the original source address refers to an IP address of computing device 101 since computing device 101 originates the first DNS query. DNS filter 103 rewrites the source address of the first DNS query in this manner because without the rewriting, the source address of the DNS query would be an IP address of the DNS filter 103 when the DNS filter 103 provides the DNS query to DNS server 104. As such, a DNS response from the DNS server 104 would be returned to the DNS filter 103 rather than to the computing device 101.

DNS server 104 may comprise a computer server that translates domain names, which are generally human-friendly names that identify websites or services on the Internet, to IP addresses, which are numerical identifiers that computers use to communicate with each other. DNS server 104 receives the second DNS query from DNS filter 103 (if the DNS query is deemed valid by the DNS filter 103). DNS server 104 may be a DNS cache server or a DNS authoritative server. A DNS cache server stores domain names and associated IP addresses from previous DNS queries, making future domain name resolutions for same domain names more efficient. A DNS authoritative server holds or is otherwise able to access IP addresses for domain names. DNS server 104 provides a DNS response to computing device 101 (e.g., due to the rewriting of the source address of the second DNS query to be an IP address corresponding to computing device 101) upon resolving the domain name in the second DNS query. A DNS response includes one or more corresponding IP addresses for the domain name in the corresponding DNS query.

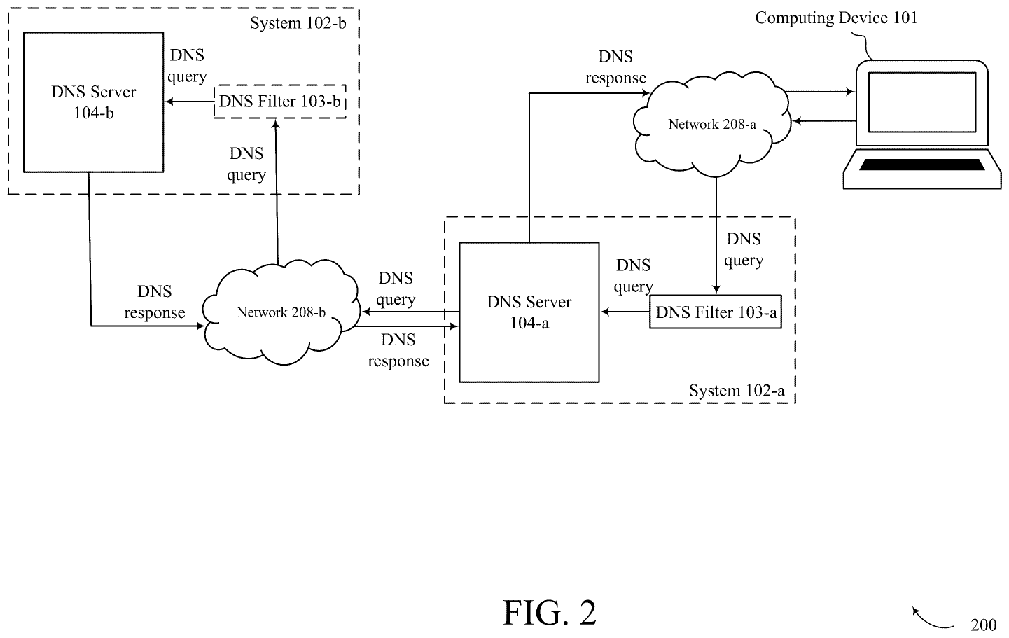

FIG. 2 discloses an example system 200 that implements systems and methods for filtering of malicious DNS queries according to aspects of the present disclosure. System 200, as presented, includes a combination of interdependent components that interact to form an integrated whole. Components of system 200 include hardware components or software components (e.g., containers, VMs) implemented on and/or executed by hardware components of system 200. In some examples, components of system 200 are distributed across multiple processing devices or computing systems. Repeated discussion of similar aspects is omitted for brevity.

System 200 may include computing device 101, system 102-a, system 102-b, DNS filter 103-a, DNS filter 103-b, DNS server 104-a (e.g., a DNS cache server), DNS server 104-b (e.g., a DNS authoritative server), network 208-a, and network 208-b. The scale and structure of devices and environments discussed herein may vary and may include additional or fewer components than those described in FIG. 2 and subsequent figures.

In examples, computing device 101 may provide a first DNS query to network 208-a. Network 208-a may be a public network or a private network. For example, network 208-a may include a local network, a provider network, a virtual private network (VPN), a proxy network, or the like. Network 208-a may provide the first DNS query to DNS filter 103-a (e.g., to system 102-a). DNS filter 103-a may filter the DNS query as previously discussed, and if the DNS query is valid, provide a corresponding second DNS query to DNS server 104-a. In some examples, DNS filter 103-a may rewrite a source address of the second DNS query to be an original source address (e.g., an IP address of computing device 101) before providing the second DNS query to DNS server 104-a.

DNS server 104-a may be a DNS cache server. As previously discussed, the DNS cache server may store domain names and associated IP addresses from previous DNS queries resolved by DNS server 104-a, making future domain name resolutions for same domain names more efficient. DNS server 104-a attempts to resolve the second DNS query. If DNS server 104-a is able to resolve the DNS query (e.g., has one or more IP addresses associated with the domain name stored or otherwise accessible by DNS server 104-a), DNS server 104-a may provide a DNS response to network 208-a, which provides the DNS response to computing device 101. Alternatively, if DNS server 104-a is not able to resolve the DNS query, DNS server 104-a may generate a third DNS query to network 208-b, the third DNS query including the same requested domain name for resolution. Network 208-b may be a public network. For example, network 208-b may include a local network, a provider network, or the like. Network 208-b may provide the third DNS query to DNS filter 103-b (e.g., to system 102-b). In examples, the source address of the third DNS query may be the DNS server 104-a so that the DNS response from DNS server 104-b may be cached at DNS server 104-a. In some examples, DNS filter 103-b filters the third DNS query as previously discussed. In examples, this additional filtering between DNS server 104-a and DNS server 104-b may be useful if, e.g., DNS server 104-a is compromised. In some examples, if the third DNS query is determined to be valid, the DNS filter 103-b generates a fourth DNS query and rewrites the source address of the fourth DNS query to be an original source address (e.g., in this case, an IP address of DNS server 104-a) before providing the fourth DNS query to DNS server 104-b. In some other examples, DNS filter 103-b may not be used if DNS server 104-a and network 208-b are known to be secure. In such examples, network 208-b provides the third DNS query to DNS server 104-b.

DNS server 104-b may be a DNS authoritative server. As previously discussed, a DNS authoritative server stores or is otherwise able to access IP addresses for domain names. In the depicted example, DNS server 104-b attempts to resolve the fourth DNS query (from DNS filter 103-b). DNS server 104-b provides a DNS response to network 208-b, which provides the DNS response to DNS server 104-a, if DNS server 104-b is able to resolve the fourth DNS query. DNS server 104-a provides the DNS response to network 208-a, which provides the DNS response to computing device 101. When DNS server 104-a receives the DNS response from DNS server 104-b via network 208-b, DNS server 104-a matches the DNS response to a stored record of the second DNS query received from DNS filter 103-a (e.g., a transaction ID) and forwards the DNS response to network 208-a, which provides the DNS response to computing device 101.

FIG. 3 illustrates a non-exclusive example process flow 300 in accordance with the present application. In some examples, some or all of the operations of process flow 300 are performed by DNS filter 103. At IN, DNS filter 103 receives a DNS query, and at OUT, DNS filter provides an updated DNS query (e.g., to DNS server 104). DNS filter 103 performs the operations of process flow 300 to determine if a received DNS query is indicative of a DNS related attack. In examples, the set of rules 105 cause the DNS filter 103 to perform the operations of FIG. 3. Repeated discussion of similar aspects is omitted for brevity.

At operation 302, DNS filter 103 inspects a query type of the DNS query. In examples, the query type may refer to a query for A, AAAA, or MX records, among other query types.

At operation 304, DNS filter 103 determines whether the query type of the DNS query is valid or invalid. DNS filter 103 may store or otherwise have access to a list of disallowed DNS query types, a list of allowed DNS query types, or both. The lists may be updated by an owner of DNS server 104, or by security analysis service 107, or both, among other entities. If the query type of the DNS query is included in the list of disallowed query types (or not included in a list of allowed query types), DNS filter 103 may log and drop the DNS query at operation 306. If the query type of the DNS query is included in the list of allowed query types (e.g., or not included in a list of disallowed query types), DNS filter 103 may proceed to the next operation. In examples, if the query type is not included in an allowed or disallowed list, DNS filter 103 may either log and drop the DNS query at operation 306, or may proceed to the next operation, based on configured preferences.

At operation 308, DNS filter 103 inspects a source address of the DNS query. The source address of the DNS query refers to the IP address from which the DNS query was provided.

At operation 310, DNS filter 103 determines whether the source address of the DNS query is included in a disallowed list. DNS filter 103 may store or otherwise have access to a list of disallowed source addresses (e.g., updated by security analysis service 107). The disallowed list may be updated by the owner of DNS server 104, or by security analysis service 107, or both, among other entities. If the source address of the DNS query is included in the disallowed list, DNS filter 103 may log and drop the DNS query at operation 306. If the source address of the DNS query is not included in the disallowed list, DNS filter 103 may proceed to the next operation. In examples, as will be appreciated, an allow list may be used instead of, or in addition to, the disallow list at operation 310.

At operation 312, DNS filter 103 inspects a payload of the DNS query. The payload includes a domain name that is being presented for resolution to an IP address.

At operation 314, DNS filter 103 determines whether the payload of the DNS query is valid or invalid. If the payload is determined to be invalid, DNS filter 103 may log and drop the DNS query at operation 306. If the payload is determined to be valid, DNS filter 103 may proceed to the next operation. In some examples, DNS filter 103 may store or otherwise have access to a list of disallowed domain names, a list of allowed domain names, or both. In other examples, the DNS filter 103 may also store or have access to syntax rules for the domain names. The lists and/or syntax rules may be updated by an owner of DNS server 104, or by security analysis service 107, or both, among other entities. If the domain name in the DNS query is included in the list of disallowed domain names or does not meet the required syntax rules (e.g., the domain name is invalid), DNS filter 103 may log and drop the DNS query at operation 306. If the domain name in the DNS query is included in a list of allowed domain names and/or not included in a list of disallowed domain names and meets the required syntax rules (e.g., the domain name is valid), DNS filter 103 may proceed to the next operation. If the domain name is not included in a list, DNS filter 103 may either log and drop the DNS query at operation 306, or may proceed to the next operation, based on configured preferences. In some examples, DNS filter 103 may determine that the payload is indicative of a DNS related attack based on the payload's syntax or other characteristics. For example, if the payload (e.g., domain name) includes characters that are not allowed (e.g., characters that are included in a disallowed hostname character list stored or otherwise accessible by DNS filter 103), or if the payload includes non-alphanumeric characters aside from hyphen, or a combination of these, then DNS filter 103 may determine that the payload is invalid. In another example, DNS filter 103 may use or otherwise have access to intelligence systems or software (e.g., artificial intelligence (AI) systems or software) configured to determine whether the payload is valid or invalid.

At operation 316, DNS filter 103 generates a second DNS query, but rewrites the second DNS query with the original source address (e.g., an IP address of computing device 101, or an IP address of DNS server 104-a if DNS filter 103 is DNS filter 103-b). DNS filter 103 then provides the second DNS query to DNS server 104.

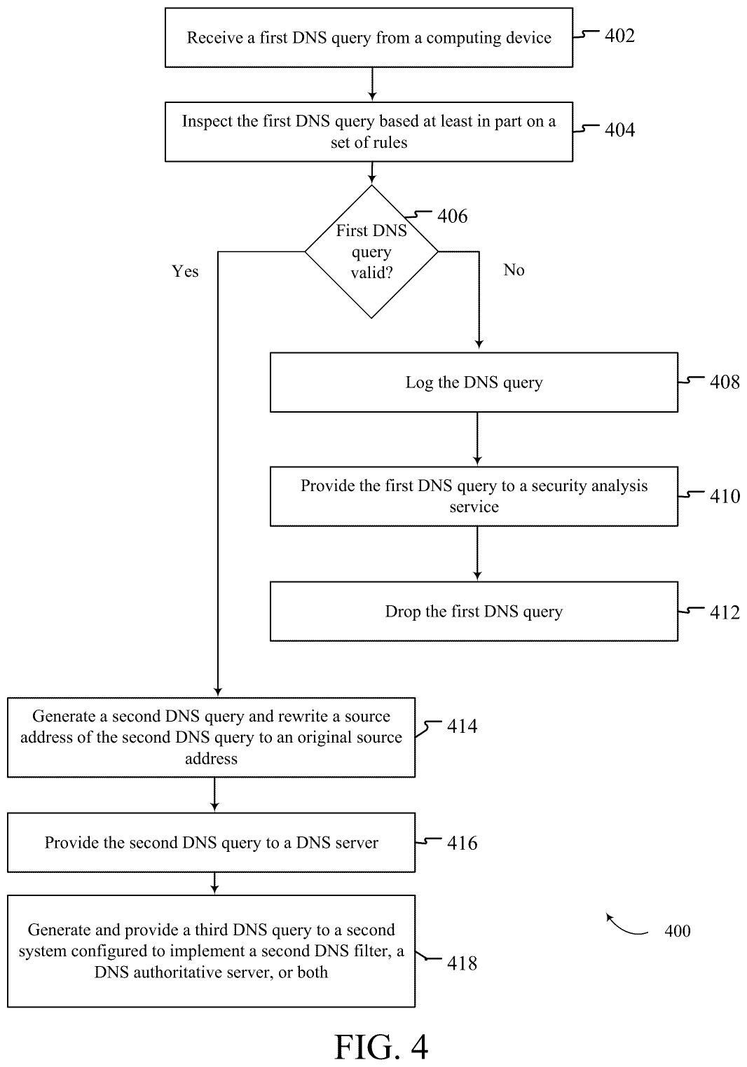

FIG. 4 illustrates an example method 400 in accordance with the present application. In examples, some or all of the operations of method 400 are performed by system 102, DNS filter 103, DNS server 104, or a combination of these.

At operation 402, the method may include receiving (e.g., by DNS filter 103) a first DNS query from a computing device (e.g., computing device 101). In some examples, the DNS filter is implemented as a container or a VM running on a same system or a different system as the DNS server.

At operation 404, the method may include inspecting (e.g., by DNS filter 103) the first DNS query based at least in part on a set of rules (e.g., the set of rules 105). In some examples, the set of rules comprises one or more criteria for the validity or invalidity of one or more DNS query attributes, the one or more DNS query attributes comprising a query type, a DNS query payload, a source address of the DNS query, or a combination thereof.

At operation 406, the method may include determining (e.g., by DNS filter 103) whether the first DNS query is either valid or invalid based at least in part on the inspection (e.g., via process flow 300).

If the first DNS query is determined not to be valid at operation 406, flow branches “no” to operation 408, and the method may include logging (e.g., by DNS filter 103) the DNS query when the first DNS query is invalid (e.g., at operation 306).

Flow proceeds from operation 408 to operation 410, and the method may include providing (e.g., by DNS filter 103) the first DNS query to a security analysis service (e.g., security analysis service 107). In some examples, the security analysis service is configured to update the set of rules based on external data, log analysis data, internal data, or a combination thereof.

Flow proceeds from operation 410 to operation 412, and the method may further include dropping (e.g., by DNS filter 103) the first DNS query. In some examples, dropping the DNS query is based at least in part on determining that the one or more DNS query attributes are indicative of a DNS related attack.

If the first DNS query is determined at operation 406 to be valid, flow may proceed “yes” to operation 414. At operation 414, the method may include generating a second DNS query. For example, the second DNS query may be a query from the DNS filter to a DNS server and include the domain name from the first DNS query. Operation 414 may also include, however, rewriting (e.g., by DNS filter 103) a source address of the second DNS query to an original source address (e.g., an IP address of computing device 101, or an IP address of DNS server 104-a if DNS filter 103 is DNS filter 103-b).

Flow proceeds to operation 416, where the method may further include providing (e.g., by DNS filter 103) the second DNS query to a DNS server (e.g., DNS server 104). In some examples, the DNS server is a DNS cache server (e.g., DNS server 104-a) or a DNS authoritative server (e.g., DNS server 104-b).

In examples, flow may proceed to operation 418, where the DNS server is the DNS cache server, and the method may further include generating and providing a third DNS query to a second system (e.g., system 102-b) configured to implement a second DNS filter (e.g., DNS filter 103-b), a DNS authoritative server (e.g., DNS server 104-b), or both. As discussed, in examples, a second DNS filter between a first DNS server and a second DNS server may be useful when the first DNS server may be compromised and made part of a DNS related attack.

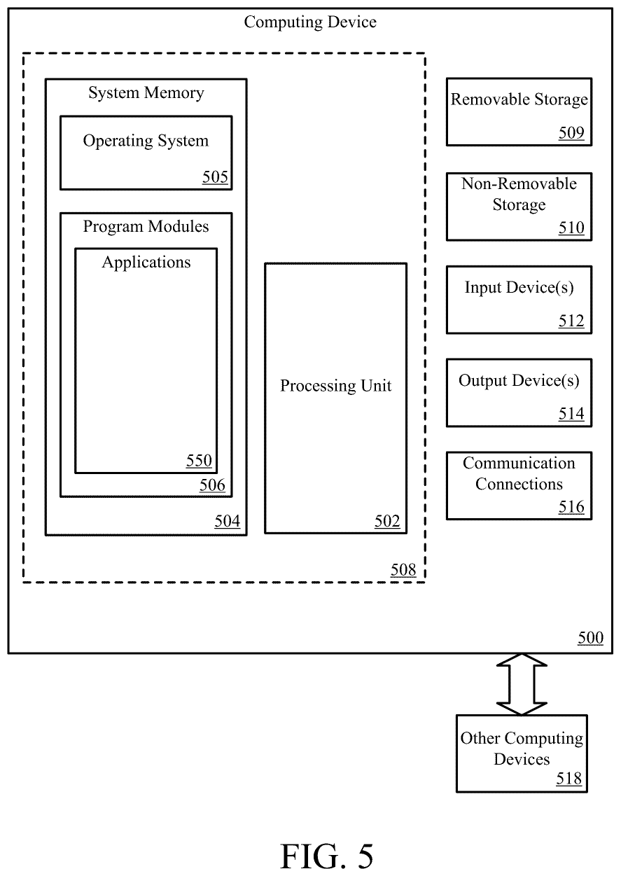

FIG. 5 is a block diagram illustrating physical components (i.e., hardware) of a computing device 500 with which examples of the present disclosure may be practiced. The computing device components described below may be suitable for a customer device implanting one or more of devices included in computing device 101, system 102, DNS filter 103, DNS server 104, or other components of FIGS. 1-2. In a basic configuration, the computing device 500 may include at least one processing unit 502 and a system memory 504. The processing unit(s) (e.g., processors) may be referred to as a processing system. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for running software applications 550 to implement one or more of the systems described above with respect to FIGS. 1-2.

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 may perform processes including, but not limited to, one or more of the operations illustrated in FIGS. 3-4. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A domain name system (DNS) filter system, comprising:
at least one processor; and
a memory operatively connected to the at least one processor and storing instructions that, when executed by the at least one processor, cause the DNS filter system to perform a method, the method comprising:
receiving a first domain name system (DNS) query from a computing device, wherein the first DNS query comprises a domain name;
inspecting the DNS query based at least in part on a set of rules;
determining that the DNS query is either valid or invalid based at least in part on the inspection;
dropping the DNS query when the DNS query is invalid;
generating, when the first DNS query is valid, a second DNS query from the DNS filter system to a DNS server, wherein the second DNS query comprises the domain name; and
sending the second DNS query.

2. The system of claim 1, wherein when the first DNS query is invalid, the method further comprises:
logging the first DNS query; and
providing the first DNS query to a security analysis service.

3. The system of claim 2, wherein the security analysis service is configured to update the set of rules based on external data, log analysis data, internal data, or a combination thereof.

4. The system of claim 1, wherein when the first DNS query is valid, the method further comprises rewriting a source address of the second DNS query to an original source address of the first DNS query.

5. The system of claim 1, wherein the DNS filter system is implemented as a container or a virtual machine (VM) running on a same computing system as the DNS server.

6. The system of claim 1, wherein the set of rules comprises one or more criteria for the validity or invalidity of one or more DNS query attributes, the one or more DNS query attributes comprising a query type, a DNS query payload, a source address of the first DNS query, or a combination thereof.

7. The system of claim 6, wherein dropping the first DNS query is based at least in part on determining that the one or more DNS query attributes are indicative of a DNS related attack.

8. The system of claim 1, wherein the DNS server is a DNS cache server or a DNS authoritative server.

9. The system of claim 1, wherein the DNS server is a DNS cache server, and wherein when the first DNS query is valid, the method further comprises sending the second DNS query to a second system configured to implement a second DNS filter, a DNS authoritative server, or both.

10. A domain name system (DNS) filtering system, comprising:
at least one processor; and
a memory operatively connected to the at least one processor and storing instructions that, when executed by the at least one processor, cause the DNS filtering system to perform a method, the method comprising:
receiving a first domain name system (DNS) query from a computing device, wherein the first DNS query comprises a domain name;
inspecting the DNS query based at least in part on a set of rules;
determining that the DNS query is either valid or invalid based at least in part on the inspection;
dropping the DNS query when the DNS query is invalid;
generating, when the first DNS query is valid, a second DNS query from the DNS filter system to a DNS server, wherein the second DNS query comprises the domain name and the generating comprises rewriting a source address of the second DNS query to an original source address of the first DNS query; and
sending the second DNS query.

11. The DNS filtering system of claim 10, wherein when the first DNS query is invalid, the method further comprises:
logging the first DNS query; and
providing the first DNS query to a security analysis service.

12. The DNS filtering system of claim 11, wherein the method further comprises updating the set of rules based on external data to the security analysis service, log analysis data, or internal data at the security analysis service.

13. The DNS filtering system of claim 10, wherein the DNS server is a DNS cache server, and wherein when the first DNS query is valid, the method further comprises sending the second DNS query to a second system configured to implement a second DNS filter, a DNS authoritative server, or both.

14. The DNS filtering system of claim 10, wherein the DNS filter system is implemented as a container or a virtual machine (VM) running on a same system computing system as the DNS server.

15. The DNS filtering system of claim 10, wherein the set of rules comprises one or more criteria for the validity or invalidity of one or more DNS query attributes, the one or more DNS query attributes comprising a query type, a DNS query payload, a source address of the first DNS query, or a combination thereof.

16. The DNS filtering system of claim 15, wherein dropping the DNS query is based at least in part on the one or more DNS query attributes being indicative of a DNS related attack.

17. The DNS filtering system of claim 10, wherein the DNS server is a DNS cache server or a DNS authoritative server.

18. A method, comprising:
receiving, at a domain name system (DNS) filter system, a first DNS query from a computing device, wherein the first DNS query comprises a domain name;
inspecting the first DNS query based at least in part on a set of rules;
determining that the first DNS query is either valid or invalid based at least in part on the inspection;
dropping the first DNS query when the first DNS query is invalid; and
generating, when the first DNS query is valid, a second DNS query from the DNS filter system to a DNS server, wherein the second DNS query comprises the domain name and the generating comprises rewriting a source address of the second DNS query to an original source address of the first DNS query; and
sending the second DNS query.

19. The method of claim 18, wherein when the first DNS query is invalid, the method further comprises:
logging the first DNS query; and
providing the first DNS query to a security analysis service.

20. The method of claim 18, wherein the set of rules comprises one or more criteria for the validity or invalidity of one or more DNS query attributes, the one or more DNS query attributes comprising a query type, a DNS query payload, a source address of the first DNS query, or a combination thereof.
